(19) United States
(12) Patent Application Publication
(10) Pub. No.: US 2022/0400701 A1
(43) Pub. Date: Dec. 22, 2022

(54) METHOD FOR PRODUCING NUTRIENTS FROM INSECTS

(71) Applicant: NEXTPROTEIN, PARIS (FR)

(72) Inventors: Mohamed GASTLI, PARIS (FR); Mathilde COQUELLE, WIMEREUX (FR); Charles DELANNOY, WIMEREUX (FR); Peggy BOUQUET, LE RHEU (FR)

(21) Appl. No.: 17/422,176

(22) PCT Filed: Jan. 10, 2020
(86) PCT No.: PCT/FR2020/050036

§ 371 Date: May 11, 2022

(30) Foreign Application Priority Data
Jan. 11, 2019 (FR) 1900268

(51) Int. Cl. A23J 3/04; A23J 3/34

(52) U.S. Cl. CPC A23J 3/04; A23J 3/34

(57) ABSTRACT

The invention relates to a method for preparing nutrients from insects, comprising the following steps: a) grinding the insects so as to obtain a ground material; b) subjecting the ground material to enzymatic hydrolysis so as to obtain a hydrolyzed ground material; c) pressing the hydrolyzed ground material so as to obtain a chitin-enriched solid fraction and a liquid fraction; and d) subjecting the liquid fraction to a physical separation so as to obtain an aqueous protein fraction and an oil fraction.

### CROSS REFERENCE TO RELATED APPLICATIONS

This application is the National Phase of PCT International Application No. PCT/FR2020/050036, filed on Jan. 10, 2020, which claims priority under 35 U.S.C. 119(a) to French Patent Application No. 1900268, filed in France on Jan. 11, 2019, all of which are hereby expressly incorporated by reference into the present application.

### TECHNICAL FIELD

The invention relates to a method for preparing nutrients from insects. The nutrients prepared may notably be used in industry, in particular in the agri-food industry and in animal feed.

### PRIOR ART

Insects are a rich nutritional supply of essential nutrients and are thus a food source of interest. The European Union moreover incorporated them into its Rule 2015/2283 as a new food, and considers that they are a foodstuff of the future. This alternative food is advantageous in the face of the agricultural and ecological challenges which populations will have to affront and of the scarcity of land. Moreover, since the nutrients obtained from insects are rich in protein and fat, their use would make it possible to replace food based on fish or soya in animal feed.

Thus, it has become essential to develop methods that make it possible to prepare nutrients from insects, notably on an industrial scale. WO 2016/108034 describes a method for preparing chitin and/or chitosan from insects by treating insect cuticles with an oxidizing agent and by enzymatic hydrolysis of the insect cuticles with a proteolytic enzyme. However, this method requires the addition of an additive to the method and does not make it possible to suitably fractionate the insects, notably to obtain a protein-enriched fraction.

Patent application WO 2013/191548 describes a method for converting insects or worms into nutrient streams in order to obtain three different fractions by enzymatic hydrolysis and then separation. However, a substantial loss of material remains, leading to a reduction in final yield, notably of the protein fraction. Moreover, the purity of the fractions obtained is not optimal.

Patent application FR 3 031 113 describes a method for producing product(s) of interest from insects, including a preliminary step of pressing the insect cuticles to separate the press juice (notably containing the oil fraction and the protein fraction) and the press cake (notably containing the chitin), followed by a step of enzymatic hydrolysis of the press cake. This method, which is essentially directed toward extracting chitin and/or chitosan, is not optimized for obtaining protein and oil fractions that are sufficiently pure and in a satisfactory yield.

There is thus a need to develop a method for preparing nutrients from insects in better yield, notably of the protein fraction. Furthermore, the need remains to obtain purer nutrient fractions, notably a purer protein fraction, namely one which is more enriched in protein and comprising little fat.

It is in this context that the Applicant developed, and this constitutes the foundation of the present invention, a method for preparing nutrients from insects, comprising the steps described below.

### SUMMARY OF THE INVENTION

The present invention, which finds an application in the food sector, is directed toward proposing a novel method for preparing nutrients from insects.

According to a first aspect, the invention relates to a method for preparing nutrients from insects, comprising the following steps:

a) grinding the insects so as to obtain a ground material,
b) subjecting the ground material to enzymatic hydrolysis so as to obtain a hydrolyzed ground material,
c) pressing the hydrolyzed ground material so as to obtain a chitin-enriched solid fraction and a liquid fraction, and
d) subjecting the liquid fraction to a physical separation so as to obtain an aqueous protein fraction and an oil fraction.

According to a second aspect, the invention relates to an aqueous protein fraction that may be obtained by performing the method according to the invention, in which at least 20% by mass of the proteins and protein fragments contained in said fraction have a molecular weight of between 1300 Da and 5700 Da.

According to a third aspect, the invention relates to an oil fraction which may be obtained by performing the method according to the invention.

According to a fourth aspect, the invention relates to a chitin-enriched solid fraction which may be obtained by performing the method according to the invention, in which the chitin content is at least equal to 15% by mass of the dry mass of said fraction.

### DETAILED DESCRIPTION

The term “nutrients” denotes organic and/or inorganic compounds used by a live organism to ensure its correct functioning. In the context of the present invention, the fractions obtained by performing the method according to the invention are considered as “nutrients” or “nutrient fractions”.

The term “insects” denotes insects at any stage in their development, such as the adult stage, the larval stage and/or the nymph stage. In the context of the present invention, the insects are preferably in the larval stage. More particularly, the insects may be chosen from coleoptera, diptera, lepidoptera, orthoptera, isoptera, hymenoptera, blattoptera, hemyptera, heteroptera, ephemeroptera and mecoptera, preferably from diptera. Preferentially, the insects are chosen from Tenebrio molitor, Hermetia illucens, Galleria mellonella, Alphitobius diaperinus, Zophobas morio, Blattera fusca, Tribolium castaneum, Rhynchophorus ferrugineus, Musca domestica, Chrysomya megacephala, Locusta migratoria, Schistocerca gregaria, Acheta domesticus, Gryllodes sigillatus, Gryllus assimillis and Samia ricini, preferably chosen from Hermetia illucens, Gryllodes sigillatus, Gryllus assimillis, Musca domestica, Tenebrio molitor, Alphitobius diaperinus and Acheta domesticus. Hermetia illucens larvae are particularly preferred in the context of the present invention.

The present invention derives from the advantages demonstrated by the inventors of the implementation of the method for preparing nutrients from insects, described below. In the context of the present description, the terms “method for preparing nutrients from insects” and “method for preparing nutrient fractions from insects” are interchangeable.

Specifically, the invention relates to a method for preparing nutrients from insects, comprising the following steps:

a) grinding the insects so as to obtain a ground material,
b) subjecting the ground material to enzymatic hydrolysis so as to obtain a hydrolyzed ground material,
c) pressing the hydrolyzed ground material so as to obtain a chitin-enriched solid fraction and a liquid fraction, and
d) subjecting the liquid fraction to a physical separation so as to obtain an aqueous protein fraction and an oil fraction.

The method according to the invention notably makes it possible to obtain nutrient fractions that are purer and/or in better yield, notably a purer aqueous protein fraction, i.e. one which is rich in protein and poor in fat.

Step a)

Step a) consists in grinding the insects so as to obtain a ground material. The ground material makes it possible to obtain a starting material of viscous consistency. The viscosity of the ground material may vary as a function of the nature and composition of the ground insects. A person skilled in the art will have no difficulty in adapting the viscosity of the ground material. For example, the desired viscosity may be readily obtained by adding more or less water before, during or after the grinding of the insects.

The grinding may be performed with a suitable grinding tool, for example a grinding mill comprising a turbine and a chopping head, a ball mill or a micro-grinding mill. The choice of the grinding tool may have an influence on the particle size of the insect particles present in the ground material. Preferably, the particle size of the insect particles present in the ground material obtained in step a) is less than 2.0 mm, notably less than 1.0 or even less than 0.5 mm. The particle size may be measured via any suitable method, for example by screening. A person skilled in the art will have no difficulty in adapting the grinding step to obtain the desired particle size. In general, the smaller the particle size, the more the hydrolysis of step b) is facilitated. A small particle size promotes the enzymatic attack and thus increases the enzymatic hydrolysis performance.

In a particular embodiment, step a) is performed at a temperature ranging from 20 to 90° C., preferentially from 40 to 70° C.

The method according to the invention is particularly advantageous since it may be performed on an industrial scale. Thus, the invention relates to an industrial method for preparing nutrients from insects. In a particular embodiment, step a) consists in grinding at least 25 kg of insects, at least 100 kg, at least 200 kg, at least 300 kg, at least 500 kg, at least 1000 kg, at least 2500 kg, at least 5000 kg or at least 7500 kg, for example at least 10 000 kg of insects. In particular, step a) consists in grinding at least 25 kg/h of insects, at least 100 kg/h, at least 200 kg/h, at least 300 kg/h, at least 500 kg/h, at least 1000 kg/h, at least 2500 kg/h, at least 5000 kg/h or at least 7500 kg/h, for example at least 10 000 kg/h of insects.

Step b)

Step b) consists in subjecting the ground material to enzymatic hydrolysis so as to obtain a hydrolyzed ground material. This step makes it possible notably to dissolve the proteins.

Certain methods described in the prior art comprise a step which consists in removing the oil fraction from the ground material before the enzymatic hydrolysis step (see, for example, the method described in FR 3 031 113). In the context of the present invention, contrary to what is described in the prior art, the ground material obtained in step a) does not undergo any separation step before the enzymatic hydrolysis step, such as a pressing step. The inventors have thus shown that it was not necessary to remove the oil fraction from the ground material before the enzymatic hydrolysis and that the yield and purity of the aqueous and oily protein fractions were thereby even improved.

In a particular embodiment, the method according to the invention does not comprise the addition of an oxidizing agent before the enzymatic hydrolysis step.

Step b) is performed by placing the ground material obtained in step a) in contact with one or more enzymes of protease type. The protease(s) may be one or more acidic, basic or neutral proteases chosen, for example, from aminopeptidases, metallocarboxypeptidases, serine endopeptidases, cysteine endopeptidases, aspartic endopeptidases, metalloendopeptidases, exopeptidases or a mixture thereof.

The following enzymes, or a mixture of several of these enzymes, may be used in step b):—Bacillus protease: Protamex (EC 3.4.21.14, Novozyme),
Casein protease: Promod 439L (Biocatalysts),
Aminopeptidases: Flavourzyme (EC 3.4.11.1, Novozyme), Fungal protease 500 (EC 3.4.11.1, Bio-Cat), Kojizyme (EC 3.4.11.1, Novozyme),
Serine endopeptidases: Protex P (EC 3.4.21, Genencor International B.V.), Chymotrypsin (EC 3.4.21.1 Novozyme), Protamex (EC 3.4.21, Novozyme), Elastase (EC 3.4.21.14, Novozyme), Trypsin (EC 3.4.21.36, Novozyme), Alcalase (EC 3.4.21.4, Novozyme),
Cysteine endopeptidases: Papain (EC 3.4.22, BSC Biochemicals), Bromelain (ananase) (EC 3.4.22.32, Bio-Cat),
Aspartic endopeptidases: Prolyve NP (EC 3.4.23, Lyven), Pepsin (EC 3.4.24.1, Sigma-Aldrich),
Metalloendopeptidases: Neutral protease (EC 3.4.24.28, Bio-Cat),
Endopeptidases: Protex 50 FP (EC 3.4.21, Genencor International B.V. (Dupont)), Sumizyme BNP-L (Takabio-Shin Nihon),
Exo and endopeptidase (protease+amylase cocktail): Pancrealyve (Lyven),
Aspartic protease: Izyme BA (EC 3.4.23, Novozyme),
Aspergillopepsin I: Sum izyme AP-L (Takabio-Shin Nihon),
   Zn-based endoprotease from beta ayloliequefaciens: Neutrase (EC 3.4.24, Novozyme),
Protease: Novozyme 37071 (Novozyme).

The amount of enzyme(s) added in step b) may be readily adjusted as a function of the enzyme(s) used so as to obtain satisfactory enzymatic activity.

The pH of the ground material may be adjusted as a function of the enzyme(s) used. For the acid proteases, the pH will be acidic, generally ranging from pH 3 to pH 6. For the alkaline proteases, the pH will be basic, generally ranging from pH 8 to pH 10. For the neutral proteases, the pH will be neutral, generally ranging from pH 6 to pH 8.

The temperature during step b) may be adjusted as a function of the enzyme(s) used and of the desired reaction rate. In a particular embodiment, step b) is performed at a temperature ranging from 40 to 70° C., for example from 50 to 55° C.

Preferably, step b) is performed with stirring, for example by placing the ground material in a tank which comprises a device for stirring the ground material. The stirring may be facilitated by adding water to the mixture, which makes it possible to reduce the viscosity, and/or by using a centrifugal pump. Stirring homogenizes the mixture and promotes the enzymatic hydrolysis, which notably makes it possible to reduce the hydrolysis time.

In a particular embodiment, the hydrolysis reaction is stopped by heating the hydrolyzed ground material, in particular to a temperature ranging from 70 to 100° C., for example by heating to 80° C. The heating inactivates the protease. Generally, the hydrolysis is stopped after 1 to 5 hours, for example after 3 to 4 hours.

In another particular embodiment, the hydrolyzed ground material is not heated to stop the hydrolysis reaction before the pressing step c). By not heating the hydrolyzed ground material, it is preserved from heat degradation, notably of the lipids contained in the ground material. This embodiment preserves the quality of the fractions obtained in step d), notably the oil fraction.

Step c)

Step c) consists in pressing the hydrolyzed ground material so as to obtain a chitin-enriched solid fraction and a liquid fraction. The chitin-enriched solid fraction corresponds to the fraction commonly known as the “press cake” or “slurry” and the liquid fraction corresponds to the fraction commonly known as the “press juice” or “filtrate”. The pressing may be performed with a suitable pressing tool, for example a screw press.

The temperature during pressing should be high enough for the lipids present in the hydrolyzed ground material (oil fraction) to be in liquid form. The temperature during pressing is generally greater than 25° C., for example between 25° C. and 100° C., between 40° C. and 100° C., between 60° C. and 100° C., or between 80 and 90° C. The choice of the temperature may depend on the nature of the lipids present in the hydrolyzed ground material.

Advantageously, the pressing tool is equipped with a screen. The screen retains the chitin-enriched solid fraction while allowing the liquid fraction to pass through. The pore size is preferably less than 3 mm, for example from 0.5 to 2 mm.

When pressing is performed with a screw press equipped with a screen, a person skilled in the art has no difficulty in choosing a suitable screen and in adjusting the pressure, for example by adjusting the screw speed and the closure of the shutter. In general, the pressure applied with a screw press ranges from 1 to 5 bar. The use of a screw press is particularly advantageous since it makes it possible to efficiently separate the chitin-enriched solid fraction and the liquid fraction at a low rotation speed (less than 50 rpm) relative to the rotation speed of decanters (generally between 3000 and 4000 rpm), which avoids the formation of an emulsion.

Contrary to the methods described in the prior art, the method according to the invention does not require any pressing step other than step c). Thus, step c) is advantageously the only pressing step of the method.

Step c) notably makes it possible to obtain a press juice essentially freed of the solid elements, in particular essentially freed of chitin. Pressing considerably facilitates the implementation of the subsequent steps performed using the press juice. Specifically, the Applicant has noted that the addition of a pressing step makes it possible to obtain particularly pure nutrient fractions, notably an aqueous protein fraction that is rich in protein and poor in lipids in step d).

The Applicant has also shown that the pressing step makes it possible to implement a physical separation step (step d) at lower temperatures than those described in the prior art, for example at a temperature ranging from 50° C. to 80° C., notably ranging from 65 to 75° C. Such a temperature preserves the liquid fraction during the physical separation, notably the quality of the oil fraction obtained in step d). Such a temperature also makes it possible to limit the oxidation of the lipids, which also preserves the quality of the oil fraction obtained in step d).

The content of chitin contained in the chitin-enriched solid fraction is preferably at least 1.5 times greater than the chitin content of the ground material, preferably at least two times greater, for example at least 2.5 times or 3 times greater. Advantageously, the chitin content is at least equal to 15% by mass of the dry mass of the chitin-enriched solid fraction, for example at least equal to 20%, at least equal to 25%, at least equal to 30%.

The chitin-enriched solid fraction may be used as obtained or transformed, for example to extract the chitin therefrom.

Chitin finds numerous applications, notably in the agrifood industry as a thickening or stabilizing additive. Chitin may also be used in the pharmaceutical industry or in animal feed.

In the context of the present invention, the liquid fraction is transformed in step d) notably to obtain aqueous and oily protein fractions, which are particularly upgradable industrially, notably in animal feed.

Step d)

Step d) consists in subjecting the liquid fraction to a physical separation so as to obtain an aqueous protein fraction and an oil fraction. The physical separation may be performed by decantation, centrifugation, reverse-osmosis separation, ultrafiltration, extraction with supercritical CO₂, or a combination of several of these separation methods.

In a preferred embodiment, the physical separation is performed with a machine for simultaneously centrifuging and decanting, for example with a plate separator or with a three-phase decanter. Such machines are commonly used in the agri-food industry to obtain, in a single step, an aqueous fraction (e.g. an aqueous protein fraction) and an oil fraction. These two fractions are free of solid residues.

Three-phase decanters are used for the simultaneous separation of two liquid phases of different densities and a solid phase. Three-phase decanters thus perform a three-phase separation (solid-liquid-liquid separation) of dispersions of solid residues and of two immiscible liquids of different density (e.g. oil fraction and aqueous protein fraction). Several three-phase decanters are proposed on the market, for example the Tricanter Flottweg three-phase decanter, the GEA three-phase decanter or the Andritz three-phase decanter.

Plate separators are also known as “clarifying separators” or “plate centrifuges”. These are high-speed centrifuges used for clarifying suspensions and/or for separating two liquids of different density (e.g. oil fraction and aqueous protein fraction). They function at higher speeds than three-phase decanters. Several plate separators are proposed on the market, for example the Flottweg plate separator, the GEA plate separator or the Alfa Laval plate separator.

In a particular embodiment, step d) makes it possible to remove the solid residues present in the liquid fraction. In this particular embodiment, the liquid fraction is subjected to a physical separation so as to obtain an aqueous protein fraction, an oil fraction and a solid residue fraction (commonly known as the “settling” fraction or the “centrifugation slurry” fraction).

Step d) may be performed at a temperature ranging from 45° C. to 90° C. As explained above, step d) may be performed at lower temperatures than those described in the prior art, for example at a temperature ranging from 50 to 80° C., notably at a temperature ranging from 65 to 75° C.

In a particular embodiment, step d) is performed with a plate separator at a temperature ranging from 50 to 80° C., for example from 65 to 75° C.

The oil fraction mainly comprises the lipids contained in the insects. The oil fraction may be filtered and/or clarified, notably by polishing or by decantation. This step makes it possible to increase the purity of the oil fraction. The oil fraction may also be transformed, for example to extract particular compounds therefrom, for instance particular fatty acids.

The aqueous protein fraction mainly comprises the proteins contained in the insects which have been hydrolyzed in step b).

Advantageously, the aqueous protein fraction which may be obtained by performing the method according to the invention has a protein content (proteins, protein fragments and free amino acids) at least equal to 60% by mass of the dry mass of said fraction, for example at least equal to 65%, 66%, 67%, 68%, 69%, 70%, 71%, 72%, 73%, 74% for example at least equal to 75% by mass of the dry mass of said fraction. The aqueous protein fraction which may be obtained by performing the method according to the invention may also have a protein content (proteins, protein fragments and free amino acids) at least equal to 80% by mass of the dry mass of said fraction, for example at least equal to 81%, 82%, 83%, 84%, 85%, or even more, by mass of the dry mass of said fraction.

Advantageously, the aqueous protein fraction which may be obtained by performing the method according to the invention has a lipid content of less than 20% by mass of the dry mass of said fraction, for example less than 15%, 14%, 13%, 12%, 10%, 9%, 8%, 7%, 6%, or even less than 5% by mass of the dry mass of said fraction.

In particular embodiments:

(i) at least 20% by mass, preferentially at least 25%, for example at least 30%, for example about 30%, of the proteins and protein fragments contained in the aqueous protein fraction have a molecular weight of less than 1300 Da;
(ii) at least 20% by mass, preferentially at least 30% by mass, even more preferentially at least 40% by mass, for example at least 50% by mass, at least 60% by mass, example about 70% by mass, of the proteins and protein fragments contained in the aqueous protein fraction have a molecular weight of greater than 1300 Da;
(iii) at least 20% by mass, for example at least 30% by mass, at least 40% by mass, at least 50% by mass, for example between 25% and 60% by mass, between 45% and 55% by mass, of the proteins and protein fragments contained in the aqueous protein fraction have a molecular weight of between 1300 Da and 5700 Da;
(iv) at least 5% by mass, for example at least 6%, at least 7%, at least 8%, at least 9%, at least 10% by mass, for example about 13% by mass, of the proteins and protein fragments contained in the aqueous protein fraction have a molecular weight of greater than 10 000 Da;
(v) the protein content (proteins, protein fragments and free amino acids) is at least equal to 60% by mass of the dry mass of said fraction, for example at least equal to 65%, 66%, 67%, 68%, 69%, 70%, 71%, 72%, 73%, 74%, for example at least equal to 75%, 80% 81%, 82%, 83%, 84%, 85%, or even more, by mass of the dry mass of said fraction; and/or
(vi) the lipid content is less than 20% by mass of the dry mass of said fraction, for example less than 15%, 14%, 13%, 12%, 10%, 9%, 8%, 7%, 6%, or even less than 5% by mass of the dry mass of said fraction.

Consequently, the aqueous protein fraction that may be obtained by performing the method according to the invention may be characterized by one, two, three, four, five or six characteristics chosen from (i), (ii), (iii), (iv), (v) and

In a preferred embodiment, the aqueous protein fraction that may be obtained by performing the method according to the invention may be characterized by characteristic (iii) and one or more characteristics chosen from (i), (ii), (iv), (v) and (vi). A content of at least 20% of proteins and protein fragments contained in the aqueous protein fraction have a molecular weight of between 1300 Da and 5700 Da is advantageous in nutritional terms and often corresponds to that which is sought by nutritionists, for example in the preparation of animal feeds. Specifically, molecular weights of less than 1000 Da combined with a large proportion of free amino acids present drawbacks with risks of diarrhea or of non-assimilation. Conversely, the higher molecular weights (for example greater than 7000 Da) are also less advantageous in terms of their digestibility and from a nutritional viewpoint.

In a particular embodiment, the proteins and protein fragments contained in the aqueous protein fraction have the molecular weight distribution of Table 6.

The aqueous protein fraction may also be dried to obtain a protein powder, for example a protein powder comprising less than 3% by mass of water. In a particular embodiment, drying makes it possible to inactivate the protease, in particular when the hydrolyzed ground material is not heated to stop the hydrolysis reaction before step c). The drying methods are well described in the literature: mention may be made, for example, of spray-drying, vacuum drying, lyophilization or the use of a drum dryer. The protein powder may be used as obtained, for example in animal feed or human food, may be transformed, for example to extract the amino acids or particular proteins therefrom, or may be incorporated into preparations intended for animal feed or human food.

Optional Steps

In a particular embodiment of the invention, the liquid fraction obtained in step c) is screened before step d). Screening makes it possible to remove the residual solid particles present in the liquid fraction. For example, the screening may be performed with a screen whose pore size is less than 1 mm, preferably less than 0.5 mm. A person skilled in the art may decide to add a screening step if he considers that the liquid fraction contains an excessive amount of residual solid particles.

In another particular embodiment of the invention, step a) is preceded by a step which consists in blanching the insects, for example by immersing them in water heated to more than 80° C., for a sufficient time. Immersion for 5 minutes in water at 90° C. is generally sufficient. The larvae are subsequently drained before performing step a). This blanching step makes it possible notably to clean the insects, in particular the larvae, and to neutralize the enzymes naturally present in the insects. The enzymes naturally present in the insects may be the cause of blackening that is undesired, notably during the preparation of the ground material in step a).

The optional steps mentioned above are not limiting and may be combined together.

The invention also relates to:

An aqueous protein fraction that may be obtained by performing the method according to the invention, in which:

(i) at least 20% by mass, preferentially at least 25%, for example at least 30%, for example about 30%, of the proteins and protein fragments contained in said fraction have a molecular weight of less than 1300 Da;
(ii) at least 20% by mass, preferentially at least 30% by mass, even more preferentially at least 40% by mass, for example at least 50% by mass, at least 60% by mass, example about 70% by mass, of the proteins and protein fragments contained in the aqueous protein fraction have a molecular weight of greater than 1300 Da;
(iii) at least 20% by mass, for example at least 30% by mass, at least 40% by mass, at least 50% by mass, for example between 25% and 60% by mass, between 45% and 55% by mass, of the proteins and protein fragments contained in the aqueous protein fraction have a molecular weight of between 1300 Da and 5700 Da;
(iv) at least 5% by mass, for example at least 6%, at least 7%, at least 8%, at least 9%, at least 10% by mass, for example about 13% by mass, of the proteins and protein fragments contained in the aqueous protein fraction have a molecular weight of greater than 10 000 Da;
(v) the protein content (proteins, protein fragments and free amino acids) is at least equal to 60% by mass of the dry mass of said fraction, for example at least equal to 65%, 66%, 67%, 68%, 69%, 70%, 71%, 72%, 73%, 74%, for example at least equal to 75%, 80% 81%, 82%, 83%, 84%, 85%, or even more, by mass of the dry mass of said fraction; and/or
(vi) the lipid content is less than 20% by mass of the dry mass of said fraction, for example less than 15%, 14%, 13%, 12%, 10%, 9%, 8%, 7%, 6% or even less than 5% by mass of the dry mass of said fraction.

Consequently, the aqueous protein fraction that may be obtained by performing the method according to the invention may be characterized by one, two, three, four, five or six characteristics chosen from (i), (ii), (iii), (iv), (v) and (vi).

In a preferred embodiment, the aqueous protein fraction that may be obtained by performing the method according to the invention is characterized by characteristic (iii) and one or more characteristics chosen from (i), (ii), (iv), (v) and (vi). A content of at least 20% of proteins and protein fragments contained in the aqueous protein fraction have a molecular weight of between 1300 Da and 5700 Da is advantageous in nutritional terms and often corresponds to that which is sought by nutritionists, for example in the preparation of animal feeds. Specifically, molecular weights of less than 1000 Da combined with a large proportion of free amino acids present drawbacks with risks of diarrhea or of non-assimilation. Conversely, the higher molecular weights (for example greater than 7000 Da) are also less advantageous in terms of their digestibility and from a nutritional viewpoint.

In a particular embodiment, the proteins and protein fragments contained in the aqueous protein fraction have the molecular weight distribution of Table 6.

By way of nonlimiting example, the aqueous protein fraction that may be obtained by performing the method according to the invention is characterized by:

(iii) at least 20% by mass, for example at least 30% by mass, at least 40% by mass, at least 50% by mass, for example between 25% and 60% by mass, between 45% and 55% by mass, of the proteins and protein fragments contained in the aqueous protein fraction have a molecular weight of between 1300 Da and 5700 Da; and
(vi) the lipid content is less than 20% by mass of the dry mass of said fraction, for example less than 15%, 14%, 13%, 12%, 10%, 9%, 8%, 7%, 6%, or even less than 5% by mass of the dry mass of said fraction.

An oil fraction that may be obtained by performing the method according to the invention.

A chitin-enriched solid fraction that may be obtained by performing the method according to the invention, in which the chitin content is at least equal to 15% by mass of the dry mass of said fraction, for example at least equal to 20%, at least equal to 25%, at least equal to 30%.

The characteristics of these three fractions are specified in steps c) and d) above.

The present invention is now illustrated with the aid of the nonlimiting examples that follow. In these examples, and unless otherwise indicated, the percentages are expressed relative to the dry mass.

### BRIEF DESCRIPTION OF THE DRAWINGS

FIG. 1 is a flow chart of the steps of a method according to the invention. The method notably comprises steps of boiling the larvae, grinding, enzymatic hydrolysis, pressing, separating with a plate separator and then drying of the aqueous protein fraction, known as the “oil-freed hydrolyzate” or the “insect protein hydrolyzate”. This flow chart corresponds to Protocol 1.

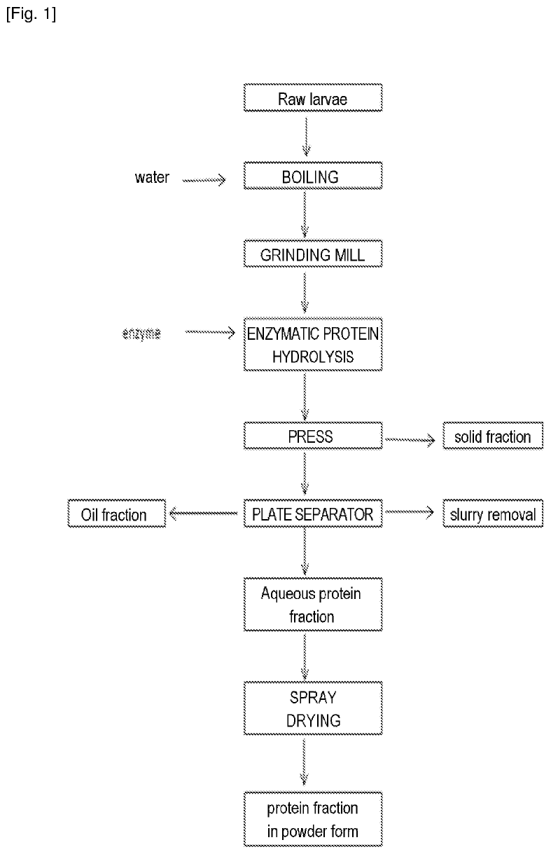

FIG. 2 is a flow chart of the steps of a method which is not according to the invention. The method notably comprises steps of boiling the larvae, grinding, enzymatic hydrolysis and separating in a centrifuge to obtain an aqueous protein fraction. The method does not comprise a pressing step. This flow chart corresponds to Protocol 2.

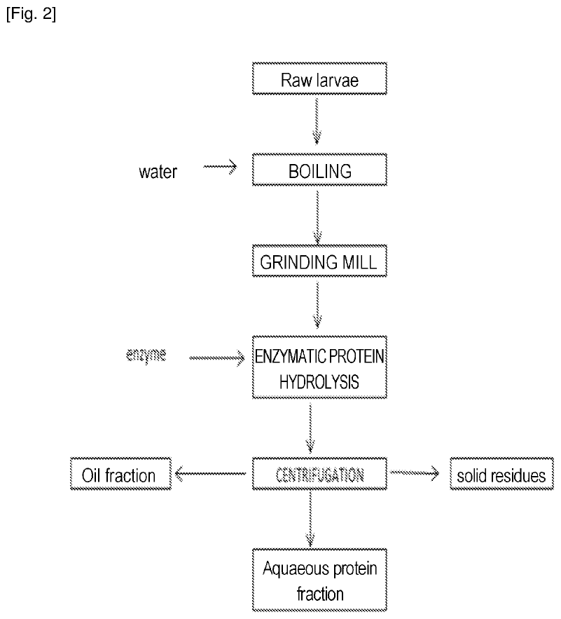

### EXAMPLE

Materials and Methods

Each content was measured on samples of each of the fractions according to the following methods:

Method for measuring the protein content (proteins, protein fragments and free amino acids): the protein content was measured by nitrogen assay on the raw material (Kjeldahl method) followed by multiplication of the nitrogen content by a coefficient of 6.38 so as to obtain the protein content of the raw material. The protein content of the raw material was multiplied by the percentage of dry mass so as to obtain the protein content by mass of the dry mass.

Method for measuring the molecular weights of the proteins and protein fragments: the aqueous protein fraction samples were passed through a gel filtration column in which the rate of migration of the molecules depends on their molecular weight: the large molecules migrate the fastest whereas the smallest emerge at the end of the analysis. The UV detector detected at 214 nm the exiting proteins. The peak size is proportional to the amount of exiting proteins. The various hydrolyzates were able to be compared by comparing the area of the peaks between given fixed times. By means of standards (reference proteins of known molecular weight: ovalbumin, lysozyme, protinin, alpha-chain insulin, human angiotensin II, L-tryptophan), a retention time equivalence as a function of the molecular weight was determined.

Method for measuring the lipid content: the lipid content was measured by MGRA-H assay by an accredited laboratory, COFRAC.

Method for measuring the chitin content: the chitin content was measured by glucosamine assay with the aid of ion chromatography. The glucosamine content is then divided by a factor of 1.062 so as to obtain the chitin content.

Method for measuring the mineral content: the mineral content was determined by measuring the total mass of the raw ash. A sample, placed in a crucible, is incinerated at 550° C. in an electric muffle furnace with a thermostat. The residue is weighed.

Protocol 1: Preparation of Nutrients from Insects—According to the Invention

165 kg of live black soldier fly (Hermetia illucens) larvae were used in this protocol. The dry mass content and the composition of the dry mass of a larval ground material are presented in Table 1.

The larvae were placed on a gauze and then immersed in water at a temperature of 90° C. for 5 minutes. The mass of the larvae after the blanching step was about 196 kg, which corresponds to a water uptake of 31 kg.

Step a)

The blanched larvae were introduced into an Urschel Comitrol 1700 brand grinding mill and ground so as to obtain a ground material with a mean particle size of 0.5 mm. The temperature of the ground material at the outlet of the grinding mill was about 40-45° C.

Step b)

The ground material was subsequently introduced into a tank with stirring with 0.4 kg of protease. The temperature was raised to 60° C. The pH was 8. In order to facilitate the stirring, water was added to the mixture during the hydrolysis.

A centrifugal pump was also installed on the reactor to improve the stirring of the mixture.

After 3 hours of stirring, the temperature of the mixture was raised to 80° C. to stop the enzymatic reaction.

Step c)

The hydrolyzed ground material was subsequently pressed with an Olexa brand screw press of MBU 75 wet-route press type equipped with a screen with a pore size of 2 mm. The temperature during the pressing was 85° C. The press shutter was adjusted so as to be three-quarters closed.

A press cake corresponding to the chitin-enriched solid fraction (mass: 18 kg) and a press juice corresponding to the liquid fraction (mass: 223 kg) were thus obtained.

The analyses of the press cake and of the press juice are presented in Table 2. The yields for this step are presented in Table 4.

Step d)

The liquid fraction heated to about 75° C. was subsequently placed in a GEA Westfalia plate separator of SAOH type, so as to obtain three fractions:
an oil fraction, with a density of about 0.9;
an aqueous protein fraction, with a density of about 1.0; and
a solid residue fraction with a density of 1.1.

The aqueous protein fraction did not have a ring of fat after centrifugation of a sample, which proves that the separation step was successfully performed. Moreover, it should be noted that no emulsion was observed with Protocol 1.

The analyses of the three fractions are presented in Table 3. The yields for this step are presented in Table 4.

Other Steps

The protein-enriched aqueous protein fraction was subsequently dried by means of a horizontal spray atomizer. The aqueous protein fraction was sprayed in the form of microspheres via nozzles in a turbine which makes it possible to generate a convergent conical hot air stream of very high density and small dimensions. The temperature of the hot air was 200-210° C. at the inlet and 90-96° C. at the outlet.

A protein powder was thus obtained from the aqueous protein fraction. The powder contained 76.8% by mass of protein.

Protocol 2: Preparation of Nutrients from Insects—Outside the Invention

0.507 kg of live black soldier fly (Hermetia illucens) larvae were used in this protocol.

The dry mass content and the composition of the dry mass of a larval ground material are presented in Table 1.

The larvae were boiled by immersion in boiling water in a laboratory reactor for 5 minutes with very gentle stirring and then placed on a screen for draining. The mass of the larvae after the blanching step was about 0.566 kg, which corresponds to a water uptake of 59 g.

Step a)

194 g of water were added to the blanched larvae, which were subsequently ground in a laboratory grinding mill equipped with a knife, for 1 minute.

Step b)

1.52 g of the same protease as used in protocol 1 were added to the ground material. The temperature was raised to 55° C. The pH was 7.2. After 4 hours of stirring, the temperature of the mixture was raised to 90° C. for 5 minutes to stop the enzymatic reaction.

The hydrolyzed ground material heated to 90° C. was subsequently placed in a bottle and centrifuged for 8 minutes at 3000×G so as to obtain four fractions:
an oil fraction, with a density of about 0.9 (45 g);
an emulsion, with a density of about 0.95 (58 g);
an aqueous protein fraction, with a density of about 1.0 (425 g); and
a solid residue fraction (223 g).

It should be noted that an emulsion was observed with Protocol 2. This emulsion was separated from the oil fraction and from the aqueous protein fraction for the analyses. The analyses of the three fractions (oil, aqueous protein and solid residues) are presented in Table 3. The yields for this step are presented in Table 5.

The aqueous protein fraction comprised 62.3% by mass of protein.

Analysis of the Fractions Obtained by Performing Protocols 1 and 2

Table 1 below corresponds to the analysis of the ground material: percentage of dry mass and content of certain constituents by mass of the dry mass.

TABLE 1

| | Percentage | | | | | |
|---|---|---|---|---|---|---|
| | of dry | | Chitin | Protein | Lipids | Others |
| | mass | Minerals | (1) | (2) | (3) | (4) |
| Protocol 1 | 33.7% | 6.1% | 8.5% | 35.1% | 48.3% | 2% |
| Protocol 2 | 36.0% | 5.3% | — | 45.9% | 48.8% | — |

(1) The chitin content was not measured in protocol 2.

(2) The protein content of the larvae of protocol 1 is evaluated by means of the total nitrogen content on the solids (6.1%) from which is subtracted the nitrogen contained in the chitin (0.6% since chitin contains 6.89% of nitrogen), i.e. 5.5% of protein nitrogen (multiplied by 6.38), i.e. 35.1% of protein in dry matter. Given that the chitin content was not measured in protocol 2, the protein content was not corrected. It is thus overestimated by about 10%.

(3) The lipid content was measured directly in protocol 1. In protocol 2, the lipid content was calculated by determining the difference with the mineral content and the protein content (100%−(% minerals+% protein)). The lipid content is probably slightly overestimated in protocol 2 (chitin not assayed).

(4) The “others” column corresponds to the difference between the dry matter and the sum of the minerals, chitin, protein and fat in protocol 1.

Table 2 below corresponds to the analysis of the liquid fraction and chitin-enriched solid fraction after pressing: percentage of dry mass and content of certain constituents by mass of the dry mass.

TABLE 2

| | Percentage | | | | | Others |
|---|---|---|---|---|---|---|
| | of dry | | | | | (by |
| | matter | Minerals | Chitin | Protein | Lipids | difference) |
| Liquid | 22.6% | 4.3% | Not | 35.3% | 57.6% | 2.8% |
| fraction | | | measured | | | |
| Chitin- | 46.3% | 7.8% | 27.5% | 38.3% | 14.9% | 11.5% |
| enriched | | | | | | |
| solid | | | | | | |
| fraction | | | | | | |

Table 3 corresponds to the analysis of the aqueous protein, oil and solid residue fractions: percentage of dry mass and content of certain constituents by mass of the dry mass.

TABLE 3

| | | Dry | | | Protein | Lipids | Others (by |
|---|---|---|---|---|---|---|---|
| | | mass | Minerals | Chitin (1) | (2) | (3) | difference) |
| Fractions | Aqueous | 10.5% | 8.3% | 0.4% | 76.8% | <4.8% | 9.7-14.5% |
| obtained | protein | | | | | | |
| according | fraction | | | | | | |
| to Protocol | Oil fraction | 64.7% | 0.5% | Not | 1.1% | 77.3% | 21.0% |
| 1 | | | | measured | | | |
| | Solid | 22.9% | 4.3% | 0.3% | 29.3% | 60.7% | 6.6% |
| | residue | | | | | | |
| | fraction | | | | | | |
| Fractions | Aqueous | 10.5% | 7.4% | Not | 62.3% | 30.4% | — |
| obtained | protein | | | measured | | | |
| according | fraction | | | | | | |
| to Protocol | Oil fraction | 98.0% | 1.7% | Not | 0.7% | 97.6% | — |
| 2 | | | | measured | | | |
| | Solid | 27.9% | 4.7% | Not | 47.0% | 49.0% | — |
| | residue | | | measured | | | |
| | fraction | | | | | | |

(1) The chitin content was not measured in protocol 2.

(2) The protein contents in protocol 2 are overestimated since the chitin nitrogen was not subtracted.

(3) For protocol 2, the lipid contents are calculated by determining the difference with the mineral content and the protein content (100%−(% minerals+% protein)).

Conclusion:

The aqueous protein fraction obtained with Protocol 1 has a higher protein content than that obtained with Protocol 2 (76.8% versus 62.3%). Furthermore, the aqueous protein fraction obtained with Protocol 1 has a lipid content which is very much lower than that obtained with Protocol 2 (4.8% versus 30.4%). These results show that the pressing step made it possible to significantly increase the purity of the aqueous protein fraction and to avoid an emulsion during the physical separation.

Yields for Protocols 1 and 2

The yield for protocol 1 corresponds to Table 4.

TABLE 4

| | | Dry | | | | | |
|---|---|---|---|---|---|---|---|
| | Mass | mass | Protein | Lipids | Minerals | Chitin | Others |
| | (kg) | (kg) | (kg) | (kg) | (kg) | (kg) | (kg) |
| Raw | 165 | 55.6 | 19.5 | 26.9 | 3.4 | 4.7 | 1.1 |
| material | | | | | | | |
| (larvae) | | | | | | | |
| Press | 18 | 8.4 | 3.2 | 1.2 | 0.7 | 2.3 | 1.0 |
| cake | | | | | | | |
| (chitin- | | | | | | | |
| enriched | | | | | | | |
| solid | | | | | | | |
| fraction) | | | | | | | |
| Press | 223 | 50.3 | 17.8 | 29.0 | 2.2 | Not | 1.4 |
| juice | | | | | | measured | |
| (liquid | | | | | | | |
| fraction) | | | | | | | |
| Total | 241.0 | 58.7 | 21.0 | 30.2 | 2.8 | 2.3 | 2.4 |
| Aqueous | 143 | 15.0 | 11.5 | <0.7 | 1.2 | Not | 1.5 |
| protein | | | | | | measured | |
| fraction | | | | | | | |
| Oil | 14.0 | 9.1 | 0.4 | 7.0 | 0.0 | Not | 1.9 |
| fraction | | | | | | measured | |
| Solid | 64.5 | 14.8 | 4.3 | 9.0 | 0.6 | Not | 0.8 |
| residue | | | | | | measured | |
| fraction | | | | | | | |
| Total | 221.5 | 38.8 | 16.3 | 16.7 | 1.9 | Not | 4.2 |
| | | | | | | measured | |

The yield for protocol 2 corresponds to Table 5.

TABLE 5

| | Mass | Dry mass | Protein | | Minerals | |
|---|---|---|---|---|---|---|
| | (g) | (g) | (kg) | Lipids (g) | (g) | Chitin (g) |
| Raw material (larvae) | 507 | 182.7 | 83.8 | 90.7 | 9.8 | Not measured |
| Solid residue fraction | 223 | 62.3 | 29.2 | 30.5 | 2.9 | Not measured |
| obtained after | | | | | | |
| centrifugation | | | | | | |
| Aqueous protein | 425 | 44.8 | 31.3 | 13.6 | 4.9 | Not measured |
| fraction obtained after | | | | | | |
| centrifugation | | | | | | |
| Oil fraction | 45 | 44.1 | 0.3 | 43.1 | 0.8 | Not measured |
| obtained after | | | | | | |
| centrifugation | | | | | | |
| Emulsion | 58 | Not | Not | Not | Not | Not measured |
| obtained after | | measured | measured | measured | measured | |
| centrifugation | | | | | | |
| Total | 751 | 151.2 | 60.8 | 87.2 | 8.6 | Not measured |

The yield for protocol 2 corresponds to Table 5.

Analysis of the Molecular Weight (Da) of the Proteins and Protein Fragments of the Aqueous Protein Fraction Obtained According to Protocol 1

Table 6 below corresponds to the analysis of the molecular weights of the proteins and protein fragments of the aqueous protein fraction obtained according to Protocol 1.

TABLE 6

| Molecular weights (MW) in Da | Percentage (%) |
|---|---|
| MW > 14 000 | 10.97% |
| 14 000 < MW > 10 000 | 2.38% |
| 10 000 < MW > 6500 | 4.86% |
| 6500 < MW > 5700 | 2.39% |
| 5700 < MW > 2500 | 24.92% |
| 2500 < MW > 1300 | 24.94% |
| 1300 < MW > 900 | 8.54% |
| 900 < MW > 600 | 9.27% |
| 600 < MW > 360 | 2.77% |
| 360 < MW > 200 | 2.48% |
| 200 < MW > 130 | 5.11% |
| MW < 130 | 1.37% |

Conclusion:

the aqueous protein fraction obtained according to Protocol 1 contains 29.54% of proteins and protein fragments with a molecular weight of less than 1300 Da relative to the total amount of proteins and protein fragments of the aqueous protein fraction. It also contains about 50% of proteins and protein fragments with a molecular weight of between 1300 Da and 5700 Da, which is particularly advantageous from a nutritional viewpoint.

1. A method for preparing nutrients from insects, comprising:
grinding the insects to obtain a ground material,
subjecting the ground material to enzymatic hydrolysis to obtain a hydrolyzed ground material,
pressing the hydrolyzed ground material to obtain a chitin-enriched solid fraction and a liquid fraction, and
subjecting the liquid fraction to a physical separation to obtain an aqueous protein fraction and an oil fraction.

2. The preparation method according to claim 1, wherein the insects are at least one of Tenebrio molitor, Hermetia illucens, Galleria mellonella, Alphitobius diaperinus, Zophobas morio, Blattera fusca, Tribolium castaneum, Rhynchophorus ferrugineus, Musca domestica, Chrysomya megacephala, Locusta migratoria, Schistocerca gregaria, Acheta domesticus, Gryllodes sigillatus, Gryllus assimillis and Sarnia ricini.

3. The preparation method according to claim 1, comprising a step prior to the grinding, comprising blanching the insects.

4. The preparation method according to claim 1, wherein the grinding results in the ground material having a particle size of less than 2.0 mm.

5. The preparation method according to claim 1, wherein the enzymatic hydrolysis of is performed with one or more proteases.

6. The preparation method according to claim 1, wherein the pressing is performed with a screw press.

7. The preparation method according to claim 1, wherein the subjecting is performed with a plate separator.

8. The preparation method according to claim 1, wherein the subjecting is performed with a plate separator at a temperature ranging from 50 to 80° C.

9. The preparation method according to claim 1, further comprising drying the aqueous protein fraction to obtain a protein powder.

10. The preparation method according to claim 1, further comprising filtering and/or clarifying the oil fraction.

11. An aqueous protein fraction obtained by,
grinding insects to obtain a ground material,
subjecting the ground material to enzymatic hydrolysis to obtain a hydrolyzed ground material,
pressing the hydrolyzed ground material to obtain a chitin-enriched solid fraction and a liquid fraction, and
subjecting the liquid fraction to a physical separation to obtain the aqueous protein fraction and an oil fraction, wherein at least 20% by mass of the proteins and protein fragments contained in said aqueous protein fraction have a molecular weight of between 1300 Da and 5700 Da.

12. The aqueous protein fraction according to claim 11, wherein a protein content comprises proteins, protein fragments and free amino acids and is at least equal to 60% by mass of the dry mass of said aqueous protein fraction.

13. The aqueous protein fraction according to claim 11, having a lipid content less than 20% by mass of the dry mass of said aqueous protein fraction.

14. An oil fraction obtained by performing the method of claim 1.

15. A chitin-enriched solid fraction obtained by,
grinding insects to obtain a ground material,
subjecting the ground material to enzymatic hydrolysis to obtain a hydrolyzed ground material,
pressing the hydrolyzed ground material to obtain a chitin-enriched solid fraction and a liquid fraction, and
subjecting the liquid fraction to a physical separation to obtain an aqueous protein fraction and an oil fraction,
wherein a chitin content of the chitin-enriched solid fraction is at least equal to 15% by mass of the dry mass of said chitin-enriched solid fraction.

16. The preparation method according to claim 10, further comprising filtering and/or clarifying the oil fraction by polishing or by decantation.

17. The preparation method according to claim 8, wherein the subjecting is performed at a temperature ranging from 65 to 75° C.

18. The preparation method according to claim 2, wherein the insects are Hermetia illucens.
